(19) United States
(12) Patent Application Publication
(10) Pub. No.: US 2014/0226954 A1
(43) Pub. Date: Aug. 14, 2014

(54) TAG WITH RADIO COMMUNICATION FUNCTION, DISPLAY APPARATUS AND RADIO COMMUNICATION SYSTEM

(71) Applicant: KABUSHIKI KAISHA TOSHIBA, Minato-ku (JP)

(72) Inventor: Toshiki Miyasaka, Saitama-Shi (JP)

(73) Assignee: KABUSHIKI KAISHA TOSHIBA, Tokyo (JP)

(21) Appl. No.: 14/013,926

(22) Filed: Aug. 29, 2013

(30) Foreign Application Priority Data
Feb. 13, 2013 (JP) 2013-25573

(51) Int. Cl. G06K 7/10; H04N 9/87

(52) U.S. Cl. CPC G06K 7/10158; H04N 9/87
USPC 386/230; 340/10.1

(57) ABSTRACT

According to an embodiment, a tag with a radio communication function includes a tag substrate, and a radio communication apparatus provided on the front surface of the tag substrate. The radio communication apparatus includes a storage unit configured to store data, a first and a second antennas, a wireless power receiver, and a first radio communicator. The wireless power receiver is configured to receive power by a first radio signal through the first antenna. The first radio communicator is configured to transmit the data by a second radio signal through the second antenna by using the power received by the wireless power receiver.

### CROSS REFERENCE TO RELATED APPLICATIONS

This application is based upon and claims the benefit of priority from the prior Japanese Patent Application No. 2013-25573, filed on Feb. 13, 2013, the entire contents of which are incorporated herein by reference.

### FIELD

Embodiments described herein relate generally to a tag with a radio communication function, a display apparatus and a radio communication system.

### BACKGROUND

A tag with a radio communication function is known which deals with a text-based message with a very small amount of data and a photograph or the like with a small amount of data. This technique cannot deal with a high resolution photograph and an HD video which have a large amount of data.

A technique is known in which two terminals having a battery compatible with TransferJet (registered trademark) are placed close to each other and data of one terminal is transmitted to the other terminal. In this technique, the batteries of the terminals need to be charged.

### BRIEF DESCRIPTION OF THE DRAWINGS

FIG. 1A is an external view of a radio communication system according to a first embodiment.

FIG. 1B is an external view of another radio communication system according to the first embodiment.

FIG. 2 is a schematic block diagram of a radio communication system according to the first embodiment.

FIG. 3A is a top view of the tag with a radio communication function according to the first embodiment.

FIG. 3B is a side view of the tag with a radio communication function according to the first embodiment.

FIG. 4 is a block diagram of the tag with a radio communication function according to the first embodiment.

FIG. 5A is an enlarged view of the tag with a radio communication function and a region around an attaching region according to the first embodiment.

FIG. 5B is an enlarged view showing a state in which the tag with a radio communication function is attached to the display apparatus according to the first embodiment.

FIG. 6 is a block diagram of the display apparatus according to the first embodiment.

FIG. 7 is a flowchart of the operation of the radio communication system according to the first embodiment.

FIG. 8 is a flowchart for explaining the operation of the radio communication system according to the modified example of the first embodiment.

FIG. 9 is a view showing an example of an icon.

FIG. 10 is a view showing another example of an icon.

FIG. 11A is an enlarged view of a tag with a radio communication function and a region around an attaching region according to the second embodiment.

FIG. 11B is an enlarged view showing a state in which the tag with a radio communication function is attached to a display apparatus according to the second embodiment.

FIG. 12A is an enlarged view of a tag with a radio communication function and a region around an attaching region according to the third embodiment.

FIG. 12B is an enlarged view showing a state in which the tag with a radio communication function is attached to a display apparatus according to the third embodiment.

FIG. 13A is an external view of a radio communication system according to a fourth embodiment.

FIG. 13B is an external view of another radio communication system according to the fourth embodiment.

FIG. 14 is a block diagram of the display apparatus according to the fourth embodiment.

FIG. 15 is an enlarged diagram of a region around attaching regions of the display apparatus according to the fourth embodiment.

### DETAILED DESCRIPTION

According to an embodiment, a tag with a radio communication function includes a tag substrate, and a radio communication apparatus provided on the front surface of the tag substrate. The radio communication apparatus includes a storage unit configured to store data, a first and a second antennas, a wireless power receiver, and a first radio communicator. The wireless power receiver is configured to receive power by a first radio signal through the first antenna. The first radio communicator is configured to transmit the data by a second radio signal through the second antenna by using the power received by the wireless power receiver.

Hereinafter, embodiments of the present invention will be described with reference to the drawings. The embodiments do not limit the present invention.

### First Embodiment

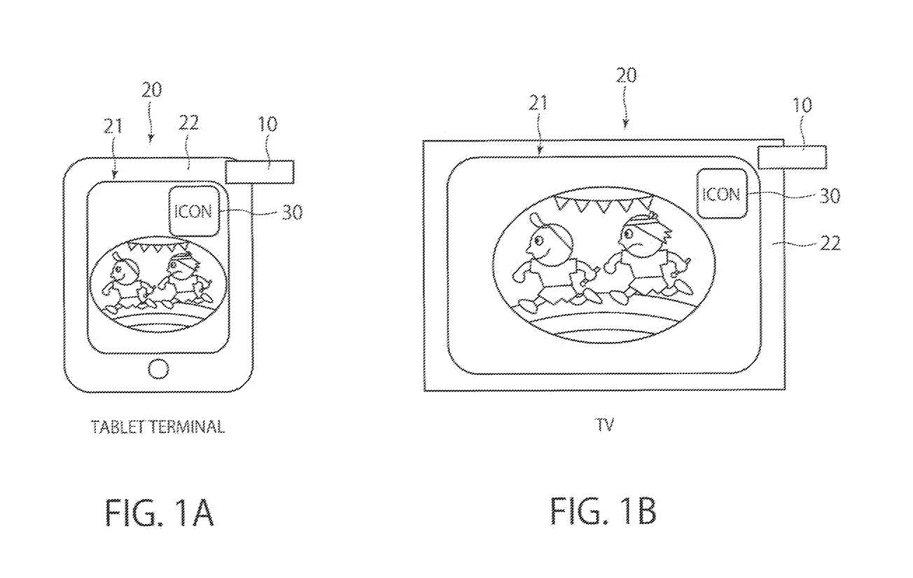

FIG. 1A is an external view of a radio communication system according to a first embodiment and FIG. 1B is an external view of another radio communication system according to the first embodiment. As shown in FIGS. 1A and 1B, the radio communication systems include a tag 10 with a radio communication function and a display apparatus 20.

The tag 10 with a radio communication function is also referred to as a label with a radio communication function and a wireless memory tag.

The display apparatus 20 is not particularly limited if the display apparatus 20 is an electronic device that can display an image including a photograph and an HD video. For example, the display apparatus 20 may be a tablet terminal, a television set, a personal computer, or a smartphone. FIG. 1A shows an example in which the display apparatus 20 is a tablet terminal and FIG. 1B shows an example in which the display apparatus 20 is a television set.

The display apparatus 20 includes a display unit 21 and a frame 22. The display unit 21 includes a liquid crystal panel or the like and displays an image. In the examples shown in FIGS. 1A and 1B, an icon 30 is displayed on the display unit 21. The frame 22 supports the display unit 21.

FIGS. 1A and 1B show a state in which the tag 10 with a radio communication function is attached to the frame 22 of the display apparatus 20.

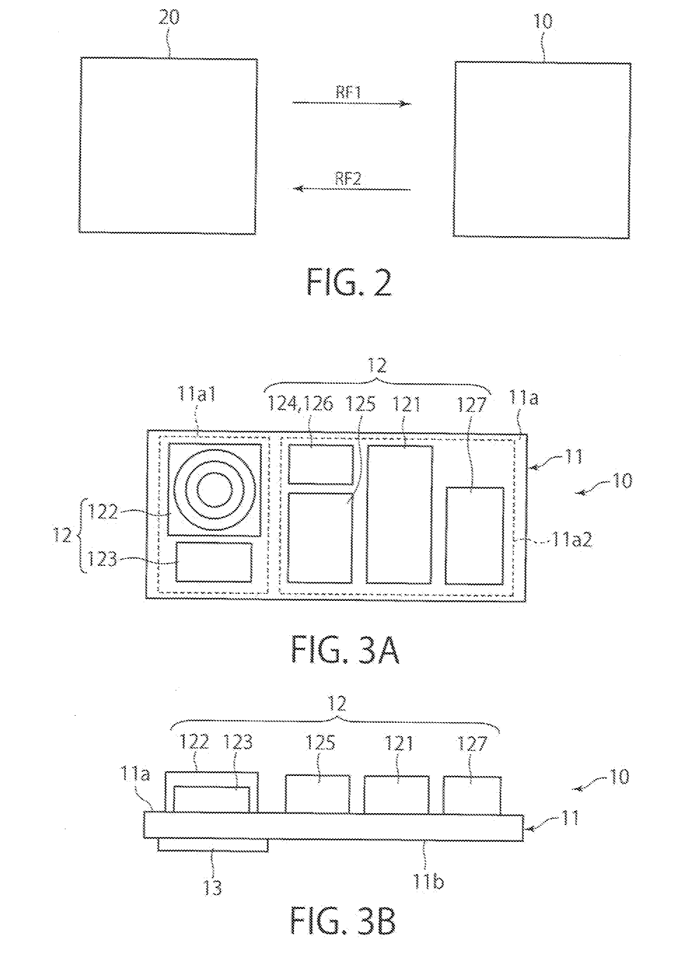

FIG. 2 is a schematic block diagram of a radio communication system according to the first embodiment. As shown in FIG. 2, the display apparatus 20 wirelessly transmits power to the tag 10 with a radio communication function by a first radio signal RF1. The tag 10 with a radio communication function transmits data to the display apparatus 20 by a second radio signal RF2 by using received power. In other words, the display apparatus 20 wirelessly communicates with the tag 10 with a radio communication function.

In the present embodiment, which is described later in detail, a user attaches the tag 10 with a radio communication function to the frame 22 of the display apparatus 20, so that the tag 10 with a radio communication function receives power from a wireless power supply coil provided in the frame 22 by surface contact, reads data stored in a memory by using the received power, and transmits the read data to an antenna provided in the frame 22 through another high-speed data communication antenna in surface contact with the frame 22. The display apparatus 20 decodes received data, so that the display apparatus 20 displays contents such as a video recorded in tag 10 with a radio communication function.

The first radio signal RF1 and the second radio signal RF2 use different frequency bands. As the first radio signal RF1, a relatively low frequency band of 100 kHz to 20 MHz is used in order to wirelessly transmit power. For example, a frequency of 13.56 MHz, which is the same as that of NFC (Near Field Communication), may be used. In mobile phones and smartphones, authentication and charging using NFC become popular. Therefore, when the same frequency as that of NFC is used for the wireless power supply, the same coil can be used as a wireless power supply coil and an NFC coil.

However, various methods such as the Qi standard are studied for the wireless power supply, so that if a small coil that can be mounted in the tag 10 with a radio communication function can be realized, not only the frequency of 13.56 MHz, but also other frequency bands may be used.

On the other hand, as the second radio signal RF2, a frequency in the UWB (Ultra Wide Band), for example, a relatively very high frequency band of 4 GHz to 60 GHz, is used in order to realize high-speed data communication of 500 Mbps to several Gbps. It is possible to transmit a large amount of data at the same time by this high-speed data communication, so that it is possible to perform file transmission and streaming reproduction of HD video contents. In the present embodiment, an example will be described in which close proximity radio communication is used as the radio communication performed by the second radio signal RF2 and TransferJet is used as the communication standard of the close proximity radio communication. In this case, it is possible to realize a physical chip data rate of 560 Mbps and an effective throughput of 375 Mbps (Max).

FIG. 3A is a top view of the tag 10 with a radio communication function according to the first embodiment and FIG. 3B is a side view of the tag 10 with a radio communication function. As shown in FIGS. 3A and 3B, the tag 10 with a radio communication function includes a tag substrate 11, a radio communication apparatus 12, and an adhesive layer 13.

The radio communication apparatus 12 includes a storage unit 121, a first antenna (coil) 122 for wireless power supply, a second antenna (coupler) 123 for UWB high-speed data communication, a wireless power receiver 124, a first radio communicator 125, a charge monitor 126, and a radio controller 127. The radio communication apparatus 12 does not have a power supply.

The tag substrate 11 is formed of a flexible substrate or a printed circuit board and has a label shape. In the example shown in FIG. 3A, the tag substrate 11 has a rectangular shape as seen in planar view. The thickness of the tag substrate 11 is not particularly limited, however, the thinner, the better, from the viewpoint of weight saving.

The radio communication apparatus 12 is provided on the front surface 11a of the tag substrate 11.

The adhesive layer 13 is provided at an end portion of the rear surface 11b of the tag substrate 11, and the adhesive layer 13 can attach the tag substrate 11, on which the radio communication apparatus 12 is provided, to the display apparatus (an object apparatus to be attached) 20. The adhesive force of the adhesive layer 13 may be set so that the attached tag 10 with a radio communication function is not peeled off by its own weight and a user can attach and peel off the tag a plurality of times. The radio communication apparatus 12 does not include a heavy power supply, so that the setting flexibility of the adhesive force of the adhesive layer 13 is high.

The first and the second antennas 122 and 123 are provided to face the adhesive layer 13 with the tag substrate 11 in between. In other words, the first and the second antennas 122 and 123 are provided on a region 11a1, on the rear surface of which the adhesive layer 13 is provided. In the present embodiment, the adhesive layer 13 is provided to cover the entire surfaces of the first and the second antennas 122 and 123. However, as long as the tag 10 with a radio communication function is stably attached to the display apparatus 20, the adhesive layer 13 may be provided to cover only a part of the surfaces of the first and the second antennas 122 and 123.

The first antenna 122 is provided adjacent to the second antenna 123.

The storage unit 121, the wireless power receiver 124, the first radio communicator 125, the charge monitor 126, and the radio controller 127 of the radio communication apparatus 12 are provided on a region 11a2, on the rear surface of which the adhesive layer 13 is not provided. However, the arrangement of each unit is not limited to the examples shown in FIGS. 3A and 3B.

Although not shown in the drawings, it is preferable that a cover which covers and protects the radio communication apparatus 12 is provided on the front surface 11a of the tag substrate 11.

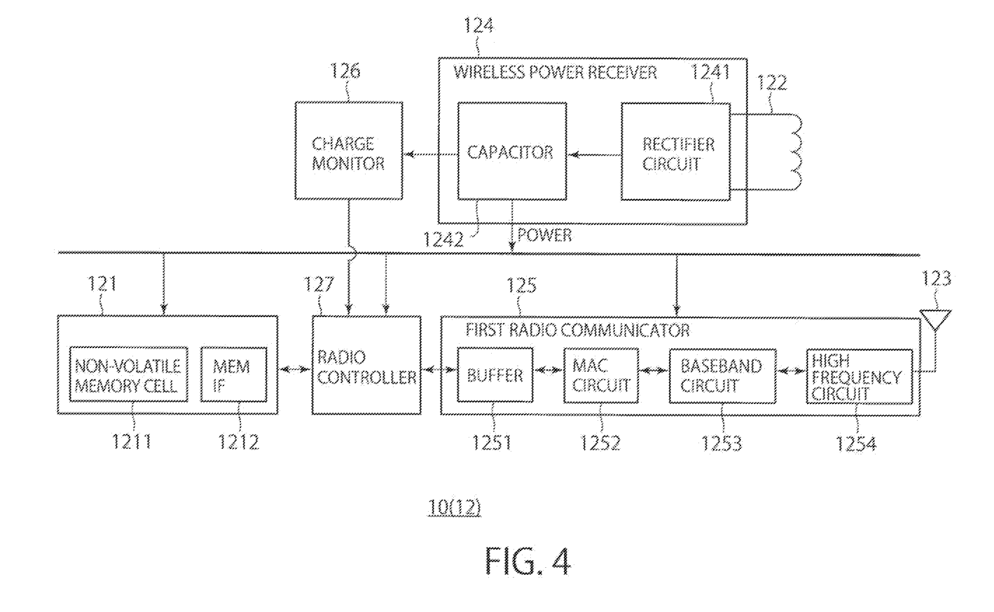

Next, functions of each unit of the radio communication apparatus 12 will be described with reference to FIG. 4.

FIG. 4 is a block diagram of the tag 10 with a radio communication function according to the first embodiment. FIG. 4 is equivalent to the block diagram of the radio communication apparatus 12.

The storage unit 121 stores data such as photographs and HD videos. In the present embodiment, the data includes icon data and video data associated with the icon data.

The storage unit 121 includes a non-volatile memory cell 1211 such as a NAND-type flash memory and an MRAM (Magnetic Random Access Memory) and a memory interface (MEM IF) 1212. Data is read from the non-volatile memory cell 1211 and written to the non-volatile memory cell 1211 by the radio controller 127 through the memory interface 1212.

The wireless power receiver 124 receives power by the first radio signal RF1 through the first antenna 122. The wireless power receiver 124 includes a rectifier circuit 1241 and a capacitor (charge holding unit) 1242. The rectifier circuit 1241 is formed from, for example, a rectifier diode and the like. The rectifier circuit 1241 converts a current flowing from the first antenna 122 into a direct current. The capacitor 1242 accumulates charges by the current converted by the rectifier circuit 1241. In other words, the capacitor 1242 holds the received power. The accumulated charges are used for process operations of each unit in the radio communication apparatus 12.

The first radio communicator 125 transmits data read from the non-volatile memory cell 1211 by the second radio signal RF2 through the second antenna 123 by using the power received by the wireless power receiver 124.

The first radio communicator 125 includes a buffer 1251, a MAC (Media Access Control) circuit 1252, a baseband circuit 1253, and a high frequency circuit 1254. The buffer 1251 temporarily stores data read from the non-volatile memory cell 1211.

The MAC circuit 1252 performs protocol control on the data stored in the buffer 1251. The baseband circuit 1253 performs signal processing such as error correction, coding processing, and modulation processing on the protocol-controlled data. The high frequency circuit 1254 transmits the second radio signal RF2 through the second antenna 123 on the basis of the signal-processed data. The first radio communicator 125 can also receive data by the second radio signal RF2 through the second antenna 123.

The charge monitor 126 monitors the charges held in the capacitor 1242.

The radio controller 127 controls the first radio communicator 125 and the storage unit 121 to read data and transmit the read data when power necessary for reading data and transmitting the read data is held in the capacitor 1242 on the basis of a notice from the charge monitor 126. More specifically, the radio controller 127 controls timing for the first radio communicator 125 to perform radio communication and timing for the wireless power receiver 124 to perform wireless power reception and accesses the storage unit 121.

Next, the display apparatus 20 will be described.

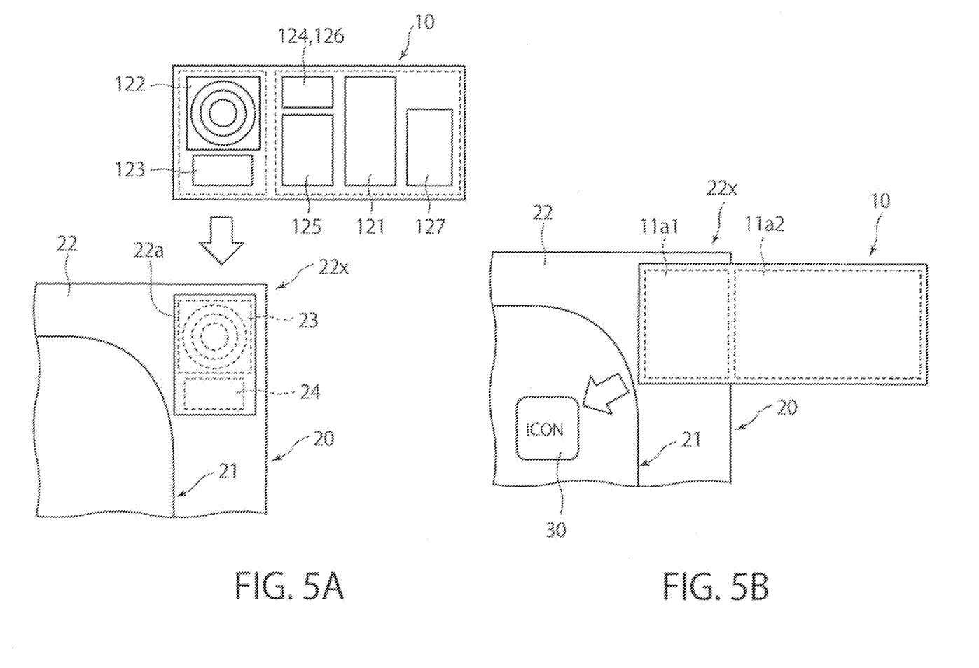

FIG. 5A is an enlarged view of the tag 10 with a radio communication function and a region around an attaching region 22a according to the first embodiment, and FIG. 5B is an enlarged view showing a state in which the tag 10 with a radio communication function is attached to the display apparatus 20.

As shown in FIG. 5A, the frame 22 includes the attaching region 22a where the tag 10 with a radio communication function is attached by the adhesive layer 13. The size of the attaching region 22a is substantially the same as the size of the adhesive layer 13. The frame 22 includes a corner portion 22x. The attaching region 22a is provided at the corner portion 22x. Thereby, a user can easily know the position of the attaching region 22a, so that the user can easily attach the tag 10 with a radio communication function. However, the attaching region 22a may be provided at a position other than the corner portion 22x as long as the attaching region 22a is on the frame 22, so that the attaching region 22a may also be provided on a side surface of the frame 22.

The display apparatus 20 includes a third antenna 23 and a fourth antenna 24. The third and the fourth antennas 23 and 24 are provided to the attaching region 22a of the frame 22. Specifically, the third and the fourth antennas 23 and 24 are buried inside the frame 22 at the attaching region 22a. The third antenna 23 is provided adjacent to the fourth antenna 24.

Since the user cannot see the third and the fourth antennas 23 and 24, in the example shown in FIG. 5A, the attaching region 22a is indicated by a line printed on the frame 22 so that the user can know the position to which the tag 10 with a radio communication function should be attached. Otherwise, for example, protrusions or the like may be provided as a mark indicating the attaching region 22a. Or, a magnet may be provided at a corner portion of the attaching region 22a and a magnet may also be provided at a corresponding corner portion of the tag 10 with a radio communication function. Thereby, when the tag 10 with a radio communication function is brought close to the attaching region 22a, the magnet of the tag 10 with a radio communication function and the magnet of the attaching region 22a attract each other, so that the tag 10 with a radio communication function can be attached to an appropriate position.

When the tag 10 with a radio communication function is attached to the attaching region 22a of the frame 22, a state shown in FIG. 5B occurs. In a state in which the tag 10 with a radio communication function is appropriately attached to the attaching region 22a, the first antenna 122 faces the third antenna 23 and the second antenna 123 faces the fourth antenna 24. Thereby, it is possible to appropriately perform transmission and reception of the first radio signal RF1 between the first antenna 122 and the third antenna 23 and transmission and reception of the second radio signal RF2 between the second antenna 123 and the fourth antenna 24.

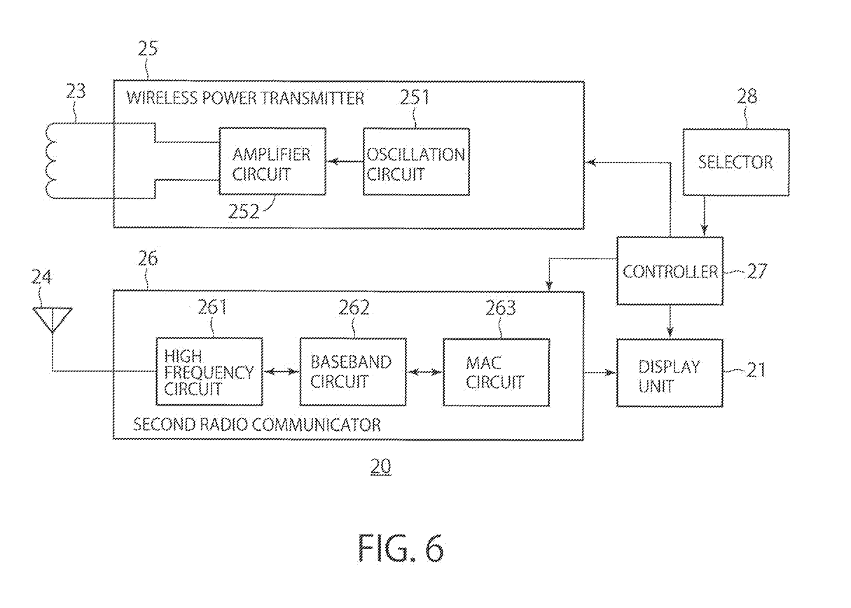

FIG. 6 is a block diagram of the display apparatus 20 according to the first embodiment. As shown in FIG. 6, the display apparatus 20 includes the display unit 21, the third antenna 23, the fourth antenna 24, a wireless power transmitter 25, a second radio communicator 26, a controller 27, and a selector 28. Although the display apparatus 20 is a tablet terminal, a television set, or the like as described above, description and explanation of a block which realizes a function of the tablet terminal, the television set, or the like and which is not directly related to the present embodiment will be omitted.

The display apparatus 20 includes a battery or a power supply (not shown in FIG. 6) and operates by using power of the battery or the power supply.

The wireless power transmitter 25 transmits power by the first radio signal RF1 through the third antenna 23. The wireless power transmitter 25 includes an oscillation circuit 251 and an amplifier circuit 252. The oscillation circuit 251 generates an oscillation signal for wirelessly transmitting power. The amplifier circuit 252 amplifies the oscillation signal. The amplified oscillation signal is applied to the third antenna 23, so that the first radio signal RF1 for transmitting power is transmitted.

The second radio communicator 26 receives data by the second radio signal RF2 through the fourth antenna 24. The second radio communicator 26 includes a high frequency circuit 261, a baseband circuit 262, and a MAC circuit 263. The high frequency circuit 261 receives the second radio signal RF2 through the fourth antenna 24. The baseband circuit 262 performs signal processing such as error correction, coding processing, and demodulation processing. The MAC circuit 263 performs protocol control on the data. The second radio communicator 26 can also transmit data by the second radio signal RF2 through the fourth antenna 24.

The controller 27 causes the display unit 21 to display an image based on the data received by the second radio communicator 26. In the present embodiment, the controller 27 causes the display unit 21 to display the icon 30 based on the received icon data (see FIGS. 1A and 1B and FIG. 5B), and when the icon 30 displayed on the display unit 21 is selected by the user, the controller 27 causes the display unit 21 to display a video based on the received video data.

The selector 28 selects the icon 30 displayed on the display unit 21 according to an operation of the user. The operation of the user may be an operation to touch a portion where the icon 30 is displayed on the display unit 21 when the display unit 21 is formed as a touch panel or an operation of a remote control.

Next, a more detailed operation of the radio communication system will be described.

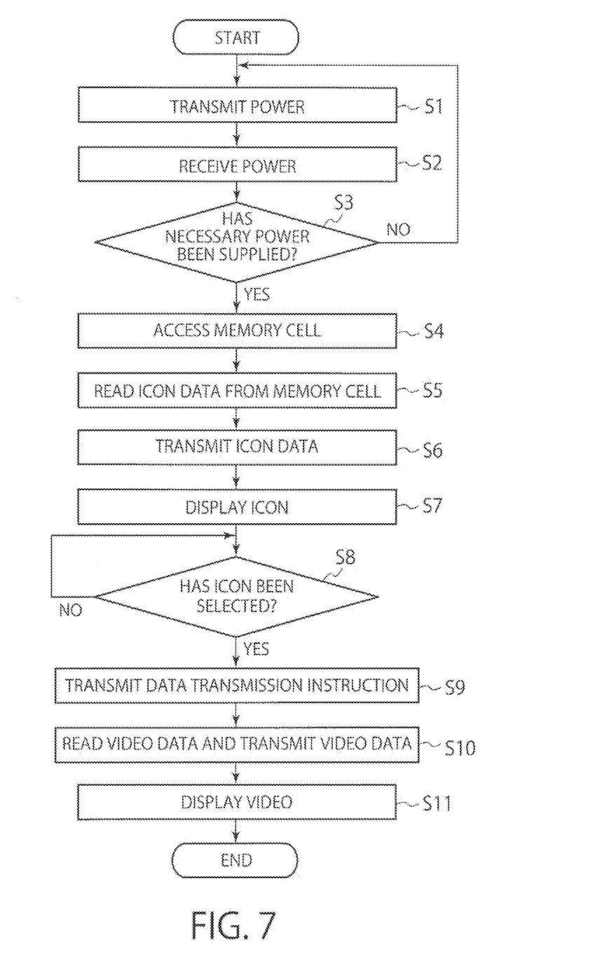

FIG. 7 is a flowchart of the operation of the radio communication system according to the first embodiment.

First, the wireless power transmitter 25 of the display apparatus 20 transmits power (step S1).

Next, when the tag 10 with a radio communication function is attached to the display apparatus 20, the wireless power receiver 124 receives the power and charges are gradually accumulated in the capacitor 1242 (step S2). When the charge monitor 126 determines that power necessary to read data and transmit the read data is not supplied and necessary charges are not accumulated in the capacitor 1242 (step S3: NO), the process returns to step S1.

When the charge monitor 126 determines that the necessary power is supplied and necessary charges are accumulated in the capacitor 1242 (step S3: YES), the radio controller 127 accesses the non-volatile memory cell 1211 (step S4) and reads the icon data from the non-volatile memory cell 1211 (step S5).

Next, in the tag 10 with a radio communication function, the radio controller 127 causes the first radio communicator 125 to transmit the icon data (step S6).

Next, in the display apparatus 20, the controller 27 causes the display unit 21 to display the icon 30 on the basis of the received icon data (step S7). Specifically, as shown in FIGS. 1A and 1B and FIG. 5B, when the tag 10 with a radio communication function is attached to the frame 22 of the display apparatus 20, the icon 30 is displayed on the display unit 21. Thereafter, the wireless power transmitter 25 may stop the power transmission.

Next, in the display apparatus 20, when the icon 30 displayed on the display unit 21 is selected by the user (step S8: YES), the controller 27 causes the second radio communicator 26 to transmit a data transmission instruction (step S9). After the step S7, if the wireless power transmitter 25 temporarily stops the power transmission, the controller 27 causes the wireless power transmitter 25 to transmit power in parallel with the processes on and after the step S9.

When the icon 30 is not selected by the user (step S8: NO), the process in step S8 is repeated.

After the step S9, in the tag 10 with a radio communication function, when the first radio communicator 125 receives the data transmission instruction, the radio controller 127 reads video data from the non-volatile memory cell 1211 and causes the first radio communicator 125 to transmit the video data by streaming (step S10).

Next, in the display apparatus 20, the controller 27 causes the display unit 21 to display the video based on the received video data (step S11) and thereby reproduces the video in a streaming manner.

As described above, in the present embodiment, data is transmitted and received by a radio communication means (the first radio communicator 125 and the second radio communicator 26) different from a power supply means (the wireless power receiver 124 and the wireless power transmitter 25). Therefore, data can be transmitted and received at high speed between the tag 10 with a radio communication function and the display apparatus 20. Therefore, it is possible to deal with an HD video and the like.

When the tag 10 with a radio communication function is attached to the frame 22 of the display apparatus 20, the first antenna 122 faces the third antenna 23 and the second antenna 123 faces the fourth antenna 24. Therefore, it is possible to see a photograph and a video stored in the tag 10 with a radio communication function on the display unit (screen) 21 of the display apparatus 20 by only attaching the tag 10 with a radio communication function to the display apparatus 20.

The first radio communicator 125 transmits data by using the power received by the wireless power receiver 124, so that the tag 10 with a radio communication function need not have a battery. Thereby, it is not necessary to charge the tag 10 with a radio communication function. Further, it is possible to save the weight of the tag 10 with a radio communication function, so that the tag 10 with a radio communication function can be stably attached to the display apparatus 20 for a long time. As a result, the tag 10 with a radio communication function is suitable for the streaming reproduction.

When the tag 10 with a radio communication function is attached to the frame 22 of the display apparatus 20, the icon 30 is displayed, and thereafter a video is displayed when the icon 30 is selected, so that it is possible to start displaying the video at any timing designated by the user.

The video is reproduced in a streaming manner, so that the video data is not left stored in the display apparatus 20. Therefore, it is preferable for reproducing a video with copyright.

In this way, the convenience of the user can be improved.

When the tag 10 with a radio communication function is attached to the display apparatus 20, the display apparatus 20 may automatically reproduce the video in a streaming manner without displaying the icon 30. In this case, the processes of steps S5 to S9 in the flowchart in FIG. 7 may be removed. In other words, when the second radio communicator 26 receives data, the controller 27 may cause the display unit 21 to display a video (image) based on the data received by the second radio communicator 26. Thereby, if the video is desired to be displayed instantly, it is possible to save the trouble for the user to select the icon 30.

The tag 10 with a radio communication function may be formed as a card with a radio communication function having a card shape such as an SD card without providing the adhesive layer 13. Such a card with a radio communication function may be used in a state in which the card is placed on the attaching region 22a of the display apparatus 20, which is a tablet terminal or the like

### Modified Example of First Embodiment

The display apparatus 20 may be configured to store all the transmitted data and display a video on the basis of the stored data without performing the streaming reproduction.

In the present modified example, the configurations of the tag 10 with a radio communication function and the display apparatus 20 are similar to those in the first embodiment, however, the function of the controller 27 of the display apparatus 20 is mainly different from that in the first embodiment. Hereinafter, points different from the first embodiment will be mainly described.

The second radio communicator 26 stores the received data. After the second radio communicator 26 receives all the data, the controller 27 causes the display unit 21 to display the icon 30 based on the data stored in the second radio communicator 26, and when the icon 30 displayed on the display unit 21 is selected by the user, the controller 27 causes the display unit 21 to display a video based on the data stored in the second radio communicator 26.

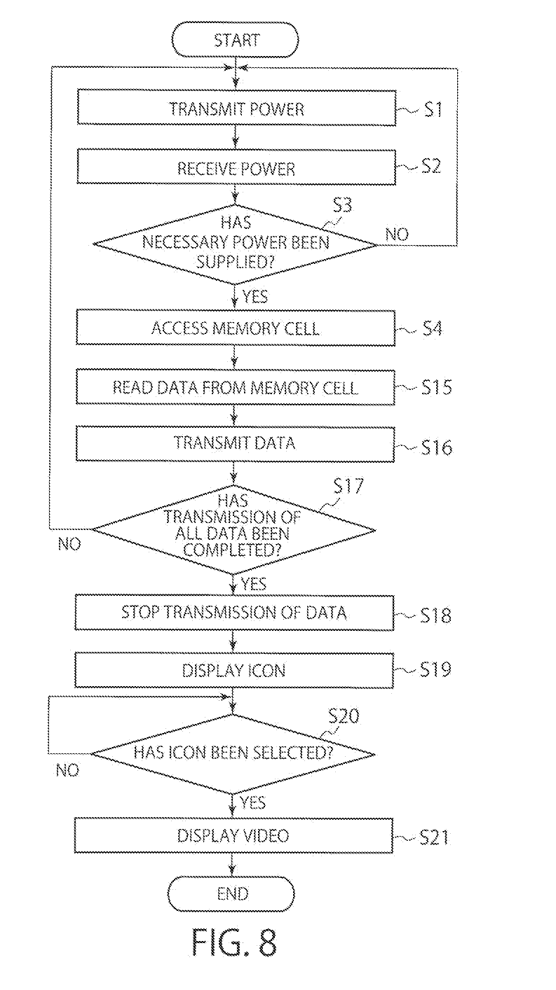

FIG. 8 is a flowchart for explaining the operation of the radio communication system according to the modified example of the first embodiment.

The processes of step S1 to step S4 are the same as those in the first embodiment. After the step S4, the radio controller 127 reads data from the non-volatile memory cell 1211 (step S15).

Next, in the tag 10 with a radio communication function, the radio controller 127 causes the first radio communicator 125 to transmit the read data (step S16). Thereby, in the display apparatus 20, the second radio communicator 26 stores the received data.

Next, in the tag 10 with a radio communication function, when the transmission of all the data in the non-volatile memory cell 1211 has not been completed (step S17: NO), the radio controller 127 returns to the process of step S1.

On the other hand, when the transmission of all the data in the non-volatile memory cell 1211 has been completed (step S17: YES), the radio controller 127 causes the first radio communicator 125 to stop the transmission of data (step S18). The radio controller 127 causes the wireless power receiver 124 to transmit a control signal to turn off the wireless power supply through the first antenna 122. When the wireless power transmitter 25 of the display apparatus 20 receives the transmitted control signal through the third antenna 23, the wireless power transmitter 25 stops the power transmission.

Next, in the display apparatus 20, the controller 27 causes the display unit 21 to display the icon 30 on the basis of the icon data stored in the second radio communicator 26 (step S19).

Next, in the display apparatus 20, when the icon 30 displayed on the display unit 21 is selected by the user (step S20: YES), the controller 27 causes the display unit 21 to display a video based on the video data stored in the second radio communicator 26 (step S21). When the icon 30 is not selected by the user (step S20: NO), the process in step S20 is repeated.

In the present modified example, the same effects as those in the first embodiment can be obtained.

Also in the present modified example, after the tag 10 with a radio communication function is attached to the display apparatus 20 and the display apparatus 20 receives all the data, the display apparatus 20 may automatically reproduce the video based on the video data stored in the second radio communicator 26 without displaying the icon 30. In this case, the processes of steps S19 and S20 in the flowchart in FIG. 8 may be removed.

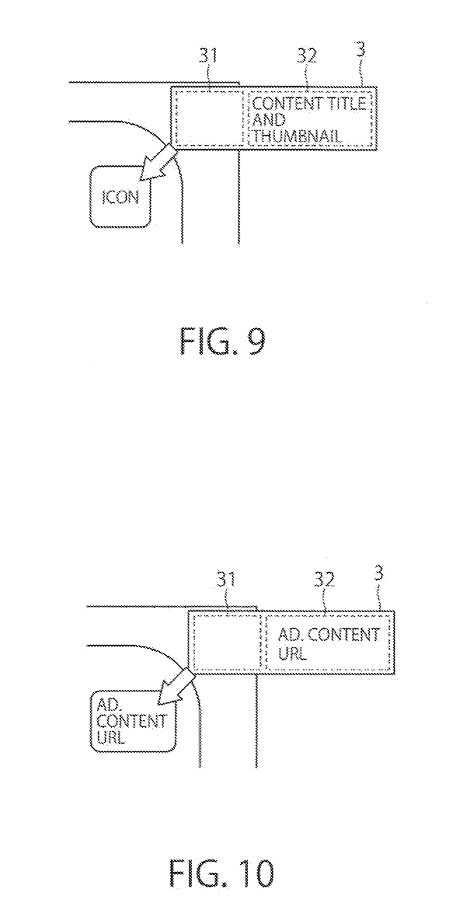

In the above embodiment, an example where the display apparatus 20 displays the video is described. However, the display apparatus 20 may display a still image (an image). For example, as shown in FIG. 9, a title and/or a thumbnail of the content is printed on the tag in advance. The display apparatus 20 may display the title and/or the thumbnail as the icon. Alternatively, as shown in FIG. 10, an advertisement content (ad. content) is printed on the tag in advance. The display apparatus 20 may display the image corresponding to the advertisement content and URL related to the advertisement content as the icon.

### Second Embodiment

The present embodiment is different from the first embodiment in a point that the second antenna is provided in a space at the center of the first antenna.

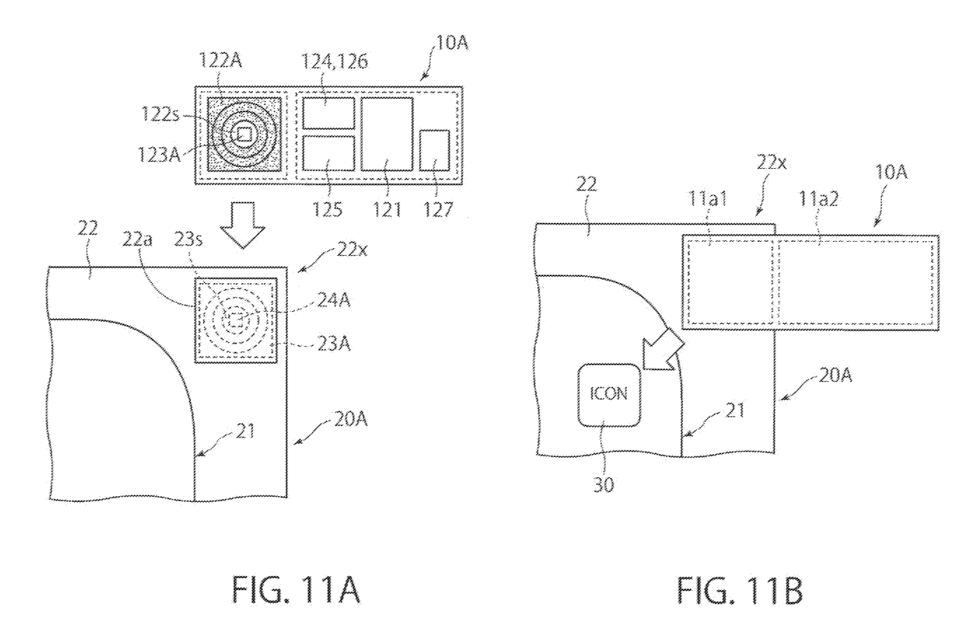

FIG. 11A is an enlarged view of a tag 10A with a radio communication function and a region around an attaching region 22a according to the second embodiment, and FIG. 11B is an enlarged view showing a state in which the tag 10A with a radio communication function is attached to a display apparatus 20A.

As shown in FIG. 11A, in the tag 10A with a radio communication function, a first antenna 122A is a planar coil including a circular space 122s at its center. A second antenna 123A is smaller than the first antenna 122A and has a substantially square shape. The second antenna 123A is provided in the space 122s at the center of the first antenna 122A. The center of the first antenna 122A substantially corresponds to the center of the second antenna 123A.

Also in the display apparatus 20A, the third antenna 23A is a planar coil including a circular space 23s at its center. A fourth antenna 24A is smaller than the third antenna 23A and has a substantially square shape. The fourth antenna 24A is provided in the space 23s at the center of the third antenna 23A. The center of the third antenna 23A substantially corresponds to the center of the fourth antenna 24A.

The first antenna 122A and the third antenna 23A have substantially the same shape and size. The second antenna 123A and the fourth antenna 24A have substantially the same shape and size.

When the tag 10A with a radio communication function is attached to the attaching region 22a of the frame 22 so that the center of the first antenna 122A corresponds to the center of the third antenna 23A, a state shown in FIG. 11B occurs. At this time, the first antenna 122A faces the third antenna 23A and the second antenna 123A faces the fourth antenna 24A.

The other components are the same as those in the first embodiment, so that the same components are denoted by the same reference numerals and the description thereof will be omitted.

According to the present embodiment, the second antenna 123A is provided in the space 122s at the center of the first antenna 122A and the fourth antenna 24A is provided in the space 23s at the center of the third antenna 23A, so that if the tag 10A with a radio communication function is attached so that the centers of the first and the third antennas 122A and 23A correspond to each other, positioning of the first and the third antennas 122A and 23A and positioning of the second and the fourth antennas 123A and 24A can be performed at the same time. Even when the tag 10A with a radio communication function is attached by being rotated any angle, it is possible to cause the first antenna 122A to face the third antenna 23A and cause the second antenna 123A to face the fourth antenna 24A.

Therefore, it is possible to easily realize stable wireless power supply as well as stable high-speed data communication.

### Third Embodiment

The present embodiment is different from the second embodiment in a point that a partition wall is provided around the second antenna and around the fourth antenna.

When the wireless power transmitter 25 has a foreign object detection function, by arranging the first and the second antennas 122A and 123A and the third and the fourth antennas 23A and 24A as in the second embodiment, the wireless power transmitter 25 may detect the second antenna 123A and/or the fourth antenna 24A as a foreign object. The foreign object detection function is a function to stop transmission of power because when there is a metal or the like other than the first antenna 122A near the third antenna 23A, the metal or the like is heated by the first radio signal RF1. As a method of detecting a foreign object, there is a method of detecting a rise in temperature.

In the present embodiment, such foreign object detection is avoided.

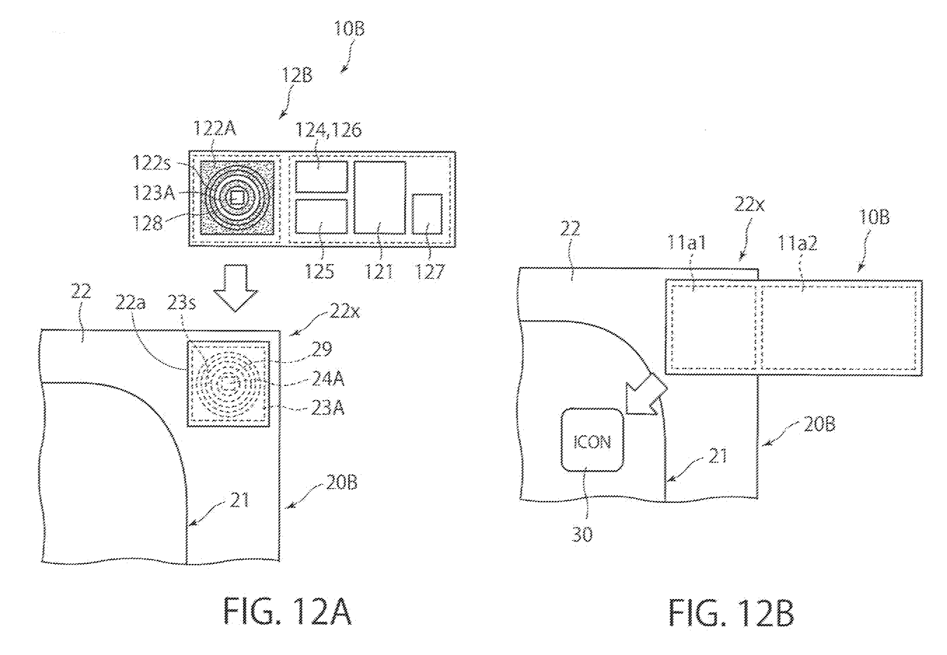

FIG. 12A is an enlarged view of a tag 10B with a radio communication function and a region around an attaching region 22a according to the third embodiment, and FIG. 12B is an enlarged view showing a state in which the tag 10B with a radio communication function is attached to a display apparatus 20B.

The radio communication apparatus 12B of the tag 10B with a radio communication function includes a cylindrical partition wall 128 which surrounds the second antenna 123A in the space 122s at the center of the first antenna 122A. The cylindrical partition wall 128 is formed of a magnetic material and reflects the first radio signal RF1. In other words, the second antenna 123A is arranged inside the cylindrical partition wall 128.

The display apparatus 20B includes a cylindrical partition wall 29 which surrounds the fourth antenna 24A in the space 23s at the center of the third antenna 23A. The cylindrical partition wall 29 is formed of a magnetic material and reflects the first radio signal RF1. In other words, the fourth antenna 24A is arranged inside the cylindrical partition wall 29. The magnetic material is, for example, ferrite. The partition wall 128 and the partition wall 29 have substantially the same shape and size.

In a state in which the tag 10B with a radio communication function is attached to the display apparatus 20B, an opening of the partition wall 128 and an opening of the partition wall 29 face each other.

According to the present embodiment, the partition walls 128 and 29 formed of ferrite are provided, so that in a state in which the tag 10B with a radio communication function is attached to the display apparatus 20B, the first radio signal RF1 is reflected by the partition walls 128 and 29. Therefore, it is possible to prevent the first radio signal RF1 from reaching the second antenna 123A and the fourth antenna 24A inside the partition walls 128 and 29 respectively. Thereby, it is possible to prevent the second antenna 123A and the fourth antenna 24A from being heated by the first radio signal RF1. Further, when the wireless power transmitter 25 has a foreign object detection function, it is possible to avoid that the second antenna 123A and/or the fourth antenna 24A are assumed to be a foreign object.

Therefore, stable wireless power supply can be implemented.

### Fourth Embodiment

The present embodiment is different from the first embodiment in a point that a plurality of tags with a radio communication function can be attached to the frame of the display apparatus.

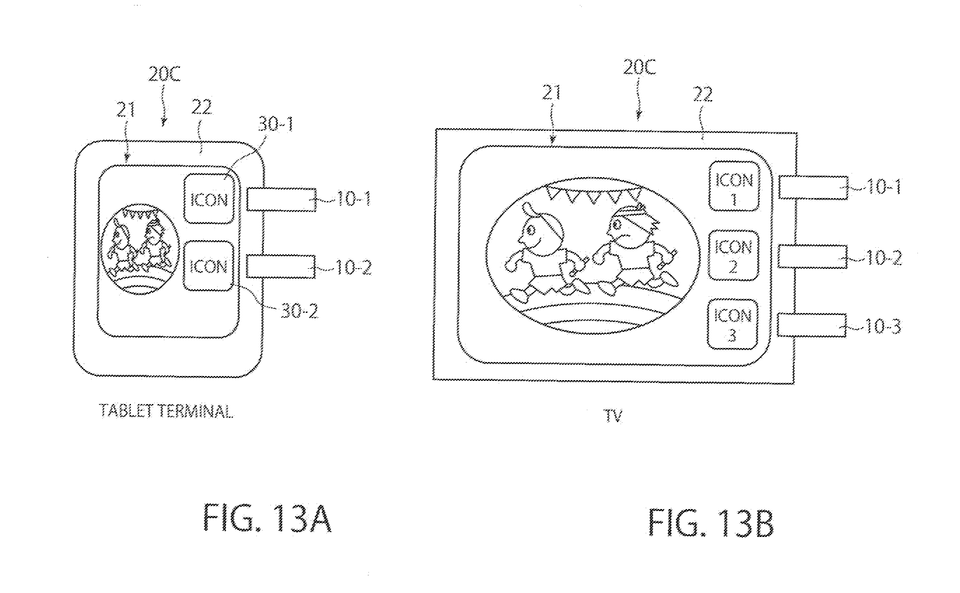

FIG. 13A is an external view of a radio communication system according to a fourth embodiment and FIG. 13B is an external view of another radio communication system according to the fourth embodiment. FIG. 13A shows an example in which the display apparatus 20C is a tablet terminal and FIG. 13B shows an example in which the display apparatus 20C is a television set.

Hereinafter, the radio communication system in FIG. 13A will be described. As shown in FIG. 13A, two tags 10-1 and 10-2 with a radio communication function are attached to the frame 22 of the display apparatus 20C. Each of the tags 10-1 and 10-2 with a radio communication function is the same as the tag 10 with a radio communication function of the first embodiment. In each of the tags 10-1 and 10-2 with a radio communication function, a video different from each other is recorded.

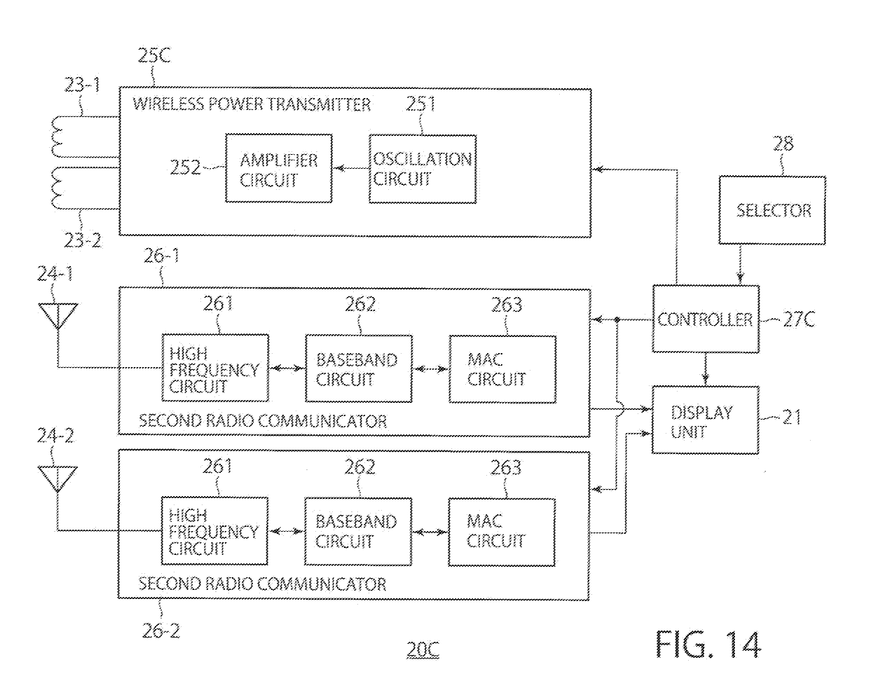

FIG. 14 is a block diagram of the display apparatus 20C according to the fourth embodiment. As shown in FIG. 14, the display apparatus 20C includes two pairs of the third and the fourth antennas 23-1, 23-2, 24-1, and 24-2 and two second radio communicators 26-1 and 26-2. Each of the third antennas 23-1 and 23-2 has the same function as that of the third antenna 23 of the first embodiment, each of the fourth antennas 24-1 and 24-2 has the same function as that of the fourth antenna 24, and each of the second radio communicators 26-1 and 26-2 has the same function as that of the second radio communicator 26. The functions of a wireless power transmitter 25C and a controller 27C are different from those in the first embodiment. The other components are the same as those in the first embodiment, so that the same components are denoted by the same reference numerals and the description thereof will be omitted.

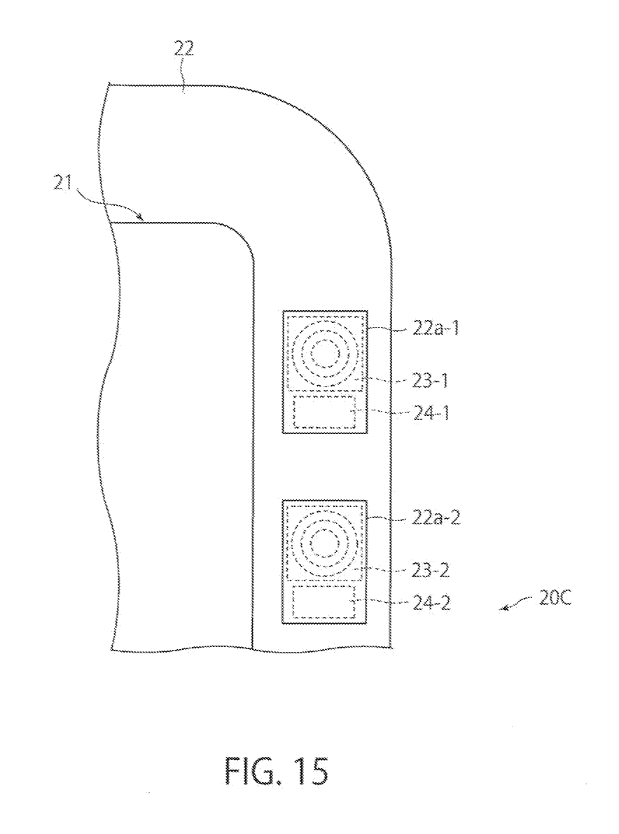

FIG. 15 is an enlarged diagram of a region around attaching regions 22a-1 and 22a-2 of the display apparatus 20C according to the fourth embodiment. As shown in FIG. 15, the frame 22 includes the two attaching regions 22a-1 and 22a-2.

The pair of the third and the fourth antennas 23-1 and 24-1 is provided to the corresponding attaching region 22a-1 and the pair of the third and the fourth antennas 23-2 and 24-2 is provided to the corresponding attaching region 22a-2. In other words, each pair of the third and the fourth antennas is provided to a corresponding attaching region.

The wireless power transmitter 25C transmits power through each of the third antennas 23-1 and 23-2. While the method of transmitting power is not particularly limited, the power may be intermittently transmitted until an icon is selected. For example, the power may be transmitted for several hundred milliseconds once per several seconds until an icon is selected.

The second radio communicator 26-1 receives data from the tag 10-1 with a radio communication function attached to the corresponding attaching region 22a-1 by the second radio signal RF2 through the corresponding fourth antenna 24-1.

The second radio communicator 26-2 receives data from the tag 10-2 with a radio communication function attached to the corresponding attaching region 22a-2 by the second radio signal RF2 through the corresponding fourth antenna 24-2.

In other words, each of the second radio communicators receives data from a tag with a radio communication function attached to a corresponding attaching region by the second radio signal RF2 through a corresponding fourth antenna.

In the present embodiment, the close proximity radio communication is employed, so that the second radio communicator 26-1 does not receive data from the tag 10-2 with a radio communication function attached to the adjacent attaching region 22a-2 by the second radio signal RF2. The second radio communicator 26-2 does not receive data from the tag 10-1 with a radio communication function attached to the adjacent attaching region 22a-1 by the second radio signal RF2.

The controller 27C displays an icon 30-1 based on the received icon data in a region near the attaching region 22a-1, where the fourth antenna 24-1 that receives the icon data is provided, on the display unit 21 (see FIG. 13A).

The controller 27C displays an icon 30-2 based on the received icon data in a region near the attaching region 22a-2, where the fourth antenna 24-2 that receives the icon data is provided, on the display unit 21 (see FIG. 13A).

In other words, the controller 27C displays an icon based on the received icon data in a region near an attaching region, where the fourth antenna that receives the icon data is provided, on the display unit 21.

To realize these, for example, in advance, the coordinates where the icon 30-1 is displayed may be associated with the MAC circuit 263 of the second radio communicator 26-1 and the coordinates where the icon 30-2 is displayed may be associated with the MAC circuit 263 of the second radio communicator 26-2.

Then, when an icon displayed on the display unit 21 is selected by the user, the controller 27C causes the display unit 21 to display a video based on the received video data corresponding to the selected icon. At this time, the controller 27C causes the wireless power transmitter 25C to continuously transmit power through the third antenna corresponding to the selected icon and causes the wireless power transmitter 25C not to transmit power through the third antenna corresponding to the icon that is not selected. Thereby, it is possible to reduce the power consumption.

For example, when the icon 30-1 is selected, the controller 27C causes the wireless power transmitter 25C to continuously transmit power through the third antenna 23-1 corresponding to the icon 30-1. Further, the controller 27C causes the second radio communicator 26-1 corresponding to the icon 30-1 to transmit a data transmission instruction. Next, in the tag 10-1 with a radio communication function corresponding to the icon 30-1, in the same manner as in the first embodiment, when the first radio communicator 125 receives the data transmission instruction, the radio controller 127 reads video data from the non-volatile memory cell 1211 and causes the first radio communicator 125 to transmit the video data by streaming. Next, the display unit 21 displays the video based on the received video data. When the icon 30-2 is selected, a similar operation is performed.

The display apparatus 20C may be configured so that three tags 10-1, 10-2, and 10-3 with a radio communication function are attached to the display apparatus 20C as shown in FIG. 13B or four or more tags 10 with a radio communication function are attached to the display apparatus 20C. In this case, the numbers of the attaching regions 22a, the pair of the third and the fourth antennas 23 and 24, and the second radio communicators 26, which will be provided, may be the same as the number of the tags 10 with a radio communication function.

According to the present embodiment, a plurality of tags 10-1 and 10-2 with a radio communication function can be attached to the display apparatus 20C and when one of the icons 30-1 and 30-2 displayed on the display unit 21 is selected by the user, the display unit 21 displays a video corresponding to the selected icon. Therefore, the user can select and reproduce any video from a plurality of videos.

Further, an icon is displayed in a region near an attaching region to which a tag with a radio communication function is attached, so that the user can easily know which icon corresponds to which tag with a radio communication function. Therefore, after a certain video has been reproduced, it is possible to easily select the tag with a radio communication function corresponding to the video from the plurality of tags 10-1 and 10-2 with a radio communication function and peel off the selected tag with a radio communication function from the frame 22.

The fourth embodiment may be combined with the second or the third embodiment.

At least a portion of the radio communication system described in the above embodiments may be constituted by hardware or software. In the software configuration, a program realizing at least a portion of the functions of the radio communication system is stored in a recording medium such as a flexible disk or a CD-ROM and may be read by a computer to be executed thereby. The storage medium is not limited to a detachable one such as a magnetic disk and an optical disk and may be a stationary recording medium such as a hard disk device and a memory.

Furthermore, the program realizing at least a portion of the radio communication system may be distributed through a communication line (including wireless communication) such as the Internet. While the program is encrypted, modulated, or compressed, the program may be distributed through a wired line or a wireless line such as the Internet, or the program stored in a recording medium may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A tag with a radio communication function comprising:
a tag substrate; and
a radio communication apparatus provided on the front surface of the tag substrate,
wherein the radio communication apparatus comprises
a storage unit configured to store data,
a first and a second antennas,
a wireless power receiver configured to receive power by a first radio signal through the first antenna, and
a first radio communicator configured to transmit the data by a second radio signal through the second antenna by using the power received by the wireless power receiver.

2. The tag with a radio communication function of claim 1, comprising:
an adhesive layer provided at a rear surface of the tag substrate, the adhesive layer being able to attach the tag substrate to an object apparatus to be attached,
wherein the first and the second antennas are provided to face the adhesive layer with the tag substrate in between.

3. The tag with a radio communication function of claim 1, wherein
the frequency of the first radio signal is lower than the frequency of the second radio signal,
the first antenna is a planar coil comprising a space at its center, and
the second antenna is smaller than the first antenna and the second antenna is provided in the space at the center of the first antenna.

4. The tag with a radio communication function of claim 3, wherein
the radio communication apparatus comprises a cylindrical partition wall configured to surround the second antenna in the space at the center of the first antenna, the cylindrical partition wall being formed of a magnetic material and reflecting the first radio signal.

5. A display apparatus configured to wirelessly communicate with a tag with a radio communication function,
the tag with a radio communication function comprising a tag substrate and a radio communication apparatus provided on the front surface of the tag substrate, the radio communication apparatus comprising a storage unit configured to store data, a first and a second antennas, a wireless power receiver configured to receive power by a first radio signal through the first antenna, and a first radio communicator configured to transmit the data by a second radio signal through the second antenna by using the power received by the wireless power receiver,
the display apparatus comprising:
a display unit;
a frame configured to support the display unit, the frame comprising a tag arrangement region where the tag with a radio communication function is arranged;
a third and a fourth antennas provided to the tag arrangement region of the frame;
a wireless power transmitter configured to transmit power by the first radio signal through the third antenna;
a second radio communicator configured to receive the data by the second radio signal through the fourth antenna; and
a controller configured to cause the display unit to display an image based on the data received by the second radio communicator.

6. The display apparatus of claim 5, wherein
the frame comprises a corner portion, and
the tag arrangement region is provided at the corner portion.

7. The display apparatus of claim 5, wherein
the data comprises icon data and image data,
the controller causes the display unit to display an icon based on the received icon data, and when the icon displayed on the display unit is selected by a user, the controller causes the display unit to display an image based on the received image data.

8. The display apparatus of claim 7, wherein
the image data is video data,
the second radio communicator does not store the received video data, and
the controller causes the display unit to display a video based on the received video data.

9. The display apparatus of claim 7, wherein
the image data is video data,
the second radio communicator stores the received video data, and
after the second radio communicator receives all the video data, the controller causes the display unit to display a video based on the received video data.

10. The display apparatus of claim 7, comprising:
a plurality of pair of the third and the fourth antennas; and
a plurality of the second radio communicator,
wherein the frame comprising a plurality of the tag arrangement region,
each pair of the third and the fourth antennas is provided to a corresponding tag arrangement region,
the wireless power transmitter transmits power through each of the third antennas,
each of the second radio communicators receives the data from the tag with a radio communication function arranged to a corresponding tag arrangement region through a corresponding fourth antenna,
the data comprises icon data and image data,
the controller displays an icon based on the received icon data in a region near the tag arrangement region, where the fourth antenna that receives the icon data is provided, on the display unit, and
when the icon displayed on the display unit is selected by the user, the controller causes the display unit to display an image based on the received image data corresponding to the selected icon.

11. The display apparatus of claim 10, wherein
the controller causes the wireless power transmitter to continuously transmit power through the third antenna corresponding to the selected icon, and
the controller causes the wireless power transmitter not to transmit power through the third antenna corresponding to the icon that is not selected.

12. The display apparatus of claim 5, wherein
the frequency of the first radio signal is lower than the frequency of the second radio signal,
the first antenna is a planar coil including a space at its center,
the third antenna is a planar coil including a space at its center,
the second antenna is smaller than the first antenna and the second antenna is provided in the space at the center of the first antenna, and
the fourth antenna is smaller than the third antenna and the fourth antenna is provided in the space at the center of the third antenna.

13. The display apparatus of claim 12, wherein
the radio communication apparatus comprises a cylindrical partition wall configured to surround the second antenna in the space of the first antenna, the cylindrical partition wall formed of a magnetic material and reflecting the first radio signal, and
the display apparatus comprises a cylindrical partition wall configured to surround the fourth antenna in the space of the third antenna, the cylindrical partition wall formed of a magnetic material and reflecting the first radio signal.

14. A radio communication system comprising:
a tag with a radio communication function; and
a display apparatus configured to wirelessly communicate with the tag with a radio communication function,
wherein the tag with a radio communication function comprises
a tag substrate, and
a radio communication apparatus provided on the front surface of the tag substrate,
wherein the radio communication apparatus comprises
a storage unit configured to store data,
a first and a second antennas,
a wireless power receiver configured to receive power by a first radio signal through the first antenna, and
a first radio communicator configured to transmit the data by a second radio signal through the second antenna by using the power received by the wireless power receiver,
wherein the display apparatus comprises
a display unit,
a frame configured to support the display unit, the frame comprising a tag arrangement region where the tag with a radio communication function is arranged,
a third and a fourth antennas provided to the tag arrangement region of the frame,
a wireless power transmitter configured to transmit power by the first radio signal through the third antenna,
a second radio communicator configured to receive the data by the second radio signal through the fourth antenna,
a controller configured to cause the display unit to display an image based on the data received by the second radio communicator.

15. The radio communication system of claim 14, wherein
the first antenna faces the third antenna with the tag substrate in between, and
the second antenna faces the fourth antenna with the tag substrate in between.

16. The radio communication system of claim 14, wherein
the frequency of the first radio signal is lower than the frequency of the second radio signal,
the first antenna is a planar coil comprising a space at its center,
the third antenna is a planar coil comprising a space at its center,
the second antenna is smaller than the first antenna and the second antenna is provided in the space at the center of the first antenna, and
the fourth antenna is smaller than the third antenna and the fourth antenna is provided in the space at the center of the third antenna.

17. The radio communication system of claim 16, wherein
the radio communication apparatus comprises a cylindrical partition wall configured to surround the second antenna in the space of the first antenna, the cylindrical partition wall formed of a magnetic material and reflecting the first radio signal, and
the display apparatus comprises a cylindrical partition wall configured to surround the fourth antenna in the space of the third antenna, the cylindrical partition wall formed of a magnetic material and reflecting the first radio signal.

18. The radio communication system of claim 14, wherein
the tag with a radio communication function comprises an adhesive layer provided at a rear surface of the tag substrate, the adhesive layer being able to attach the tag substrate to an object apparatus to be attached, and
the first and the second antennas are provided to face the adhesive layer with the tag substrate in between.

19. The radio communication system of claim 14, wherein
the frame comprises a corner portion, and
the tag arrangement region is provided at the corner portion.

20. The radio communication system of claim 14, wherein
the data comprises icon data and image data, and
the controller causes the display unit to display an icon based on the received icon data, and when the icon displayed on the display unit is selected by a user, the controller causes the display unit to display an image based on the received image data.
